(19) United States
(12) Patent Application Publication
(10) Pub. No.: US 2016/0196354 A1
(43) Pub. Date: Jul. 7, 2016

(54) METHOD TO MODIFY EXISTING QUERY BASED ON RELEVANCE FEEDBACK FROM SOCIAL POSTS

(71) Applicant: ADOBE SYSTEMS INCORPORATED, SAN JOSE, CA (US)

(72) Inventors: BALAJI VASAN SRINIVASAN, BANGALORE (IN); KARTIK SREENIVASAN, BANGALORE (IN); NIKHIL MOHAN NAINANI, MUMBAI (IN); TANYA GOYAL, CHANDIGARH (IN)

(21) Appl. No.: 14/590,362

(22) Filed: Jan. 6, 2015

(51) Int. Cl. G06F 17/30

(52) U.S. Cl. CPC G06F 17/30867; G06F 17/30528; G06F 17/30554; G06F 17/30507; G06F 17/30395

(57) ABSTRACT

The collection of social data from social networking services for market research purposes is improved by automatically modifying existing search queries based on relevance feedback. Social mentions derived from a query rule set comprising a plurality of query sub-rules are displayed. Inputs classifying selected social mentions from the plurality of social mentions are received. A subset of query sub-rules from the plurality of query sub-rules is analyzed. At least one of the query sub-rules in the subset is modified based on the analysis of the query sub-rules in the subset to filter out at least some irrelevant social mentions derived from the query rule set.

### BACKGROUND

Social networking platforms have become an increasingly popular presence on the Internet. Social network services allow users to easily connect with friends, family members, and other users in order to share, among other things, comment regarding activities, interests, and other thoughts. As social networking has continued to grow, companies have recognized value in the technology. For instance, companies have found that social networking provides a great tool for managing their brand and driving consumers to their own web sites or to otherwise purchase their products or services. Companies can create their own social networking profiles for communicating with consumers via social networking posts and other messages. Additionally, since users often employ social networking to comment on products and services, companies can mine social data to identify what consumers are saying about the company, as well as its products, services, and industry in general. In some cases, companies may even choose to respond to consumers' comments on social networks.

### SUMMARY

This summary is provided to introduce a selection of concepts in a simplified form that are further described below in the Detailed Description. This summary is not intended to identify key features or essential features of the claimed subject matter, nor should it be used as an aid in determining the scope of the claimed subject matter.

Embodiments of the present invention generally relate to modifying social search queries based on relevance feedback for social mentions. Social mentions are derived from a query rule set comprised of a plurality of query sub-rules. Inputs classifying selected social mentions as being relevant or irrelevant are received. A subset of query sub-rules from the plurality of query sub-rules is analyzed. The query rule set is modified based on the analysis to filter out at least some of the irrelevant posts derived from the query rule set.

### BRIEF DESCRIPTION OF THE DRAWINGS

The present invention is described in detail below with reference to the attached drawing figures, wherein:

FIG. 1 is a block diagram of an exemplary system architecture in which embodiments of the invention may be employed;

FIG. 2 is a flow diagram showing a method for automatically modifying existing search queries based on relevance feedback in accordance with an embodiment of the present invention;

FIG. 3 is a flow diagram showing a method for automatically modifying existing search queries based on relevance feedback in accordance with an embodiment of the present invention; and

FIG. 4 is a block diagram of an exemplary computing environment suitable for use in implementing embodiments of the present invention;

### DETAILED DESCRIPTION

The subject matter of the present invention is described with specificity herein to meet statutory requirements. However, the description itself is not intended to limit the scope of this patent. Rather, the inventor has contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various terms are used throughout this description. Definitions of some terms are included below to provide a clearer understanding of the ideas disclosed herein:

The terms “social networking service” and “social networking site” refer to any online presence at which a user may share comments with other users within a social network. For instance, this may include services, such as the TWITTER, FACEBOOK, LINKEDIN, TUMBLR, QUORA, and YOUTUBE services, to name a few.

A “social analysis tool” refers to software that facilitates companies' analysis of social networks. Among other things, a social analysis tool may be used by a company to collect information from social networking services and to manage social content and messages using social network services.

A “query sub-rule” refers to criteria, such as text, phrases, and/or metadata, used to capture social data from social networking services that is provided to and/or displayed within a moderation tool as social mentions. In some instances, the criteria may include Boolean operators.

A “query rule set” refers to a defined set of one or more query sub-rules used to capture social mentions from one or more identified social networking services. In some instances, the query sub-rules may be joined using Boolean operators.

A “social mention” includes any social networking message or post that matches the criteria set forth by one or more query sub-rules. A social mention may include both the text of a social networking message or post and metadata associated with the message or post. In some instances, a social mention is referred to as being captured by the one or more query sub-rules.

A “moderation tool” refers to a component of a social analysis tool that receives social mentions captured using a query rule set and allows a moderator to review the social mentions and take moderation actions on the social mentions.

A “moderation action” refers to any action that may be taken for a social mention. This may include, for instance, responding to a social message (e.g., responding to a tweet from a consumer using the TWITTER service), resending a social message (e.g., retweeting a tweet), liking a social message, or reporting an author who repeatedly posts bad content as a spammer. In some instances, a moderation action may be an action internal to a company, such as flagging a social mention for escalation or review by another moderator within the company. In other instances, a moderation action may include a judgment, on behalf of a moderator, to determine whether a particular social mention is relevant or irrelevant to their query preferences.

A “moderator” is a person who is responsible for reviewing social mentions for a company and deciding whether to take moderation actions on certain social mentions. For instance, a moderator can be a marketer conducting marketing research for the company. In other instances, the moderator can be a person in charge of administering social media interactions between the company and its consumers. The moderator can also be an administrator responsible for modifying query rule sets to minimize the capture of irrelevant social mentions.

To assist companies in their social networking efforts, some social analysis tools, such as the ADOBE SOCIAL tool, have been developed that provide mechanisms for companies to collect information regarding what consumers are saying and manage responses to consumers' social networking messages. These social analysis tools allow companies to set rules for capturing social data from social networks. The captured social data may be provided by a social analysis tool as a list of social mentions that each may include the text of a social networking message and metadata associated with the message. A person (i.e., a moderator) may review each social mention and determine to take moderation actions on some of the social mentions, such as posting responses to the social networking messages. Often, a large number of social mentions are captured, but moderation actions are taken on a very small subset of those social mentions. Therefore, the rules are typically too broad, and a moderator has too much data to sift through to find the small subset of social mentions to take actions on.

Embodiments of the present invention are generally directed to improving existing social query rule sets in order to reduce the number of irrelevant social mentions while providing social mentions that are likely to be of relevance to the company and moderated. By receiving relevance feedback for social mentions derived from an initial query rule set, the query rule set is automatically modified based on moderator inputs classifying some of the social mentions as relevant or irrelevant. Generally, social mentions captured using an initial query rule set and classified by the moderator as relevant or irrelevant are analyzed to identify query sub-rules in the query rule set that need to be modified. For instance, for each query sub-rule in the query rule set, only the classified social mentions associated with the query sub-rule are analyzed. In other words, social mentions are associated with or correspond to a query sub-rule when the social mentions are returned by the query rule set solely as a result of the query sub-rule being in the query rule set. In some embodiments, if every social mention associated with a particular query sub-rule is classified as irrelevant by the moderator, the entire query sub-rule is removed from the query rule set. In other embodiments, if a particular query sub-rule is associated with both relevant and irrelevant social mentions, the associated social mentions are analyzed to determine a set of top keywords from both the relevant and irrelevant social mentions. Each of the top keywords are iteratively appended to the query sub-rule to determine the effectiveness of the top keyword in filtering out irrelevant social mentions. For instance, each top keyword is appended to the query sub-rule in such a fashion so as to filter out social mentions associated with the query sub-rule not including the top keyword (i.e., preceded by a Boolean NOT operator). In some embodiments, a distribution of relevant and irrelevant social mentions is observed for each modified query sub-rule. For instance, if a computed ratio of irrelevant social mentions to relevant social mentions surpasses an empirically determined threshold, then the top keyword is included in the query sub-rule, otherwise it may be discarded. In some other embodiments, a quality parameter can be variably configured to adjust the quality of results generated from the modifications.

Accordingly, in one aspect, an embodiment of the present invention is directed to a non-transitory computer storage medium storing computer-useable instructions that, when used by one or more computing devices, cause the one or more computing devices to perform operations. The operations include displaying a plurality of social mentions derived from a query rule set, the query rule set being comprised of a plurality of query sub-rules. The operations also include receiving inputs classifying selected social mentions from the plurality of social mentions, each of the selected social mentions being classified as one of relevant and irrelevant. The operations also include analyzing a subset of query sub-rules from the plurality of query sub-rules, each query sub-rule from the subset corresponding to at least one of the selected social mentions. The operations further include modifying at least one of the query sub-rules in the query rule set based on the analysis of the subset of query sub-rules to filter out at least some irrelevant social mentions derived from the query rule set.

In another embodiment of the invention, an aspect is directed to a computer-implemented method. The method includes displaying, by a computing device, a plurality of social mentions derived from a query rule set, the query rule set being comprised of a plurality of query sub-rules. The method also includes receiving inputs classifying selected social mentions from the plurality of social mentions, each of the selected social mentions being classified as one of relevant and irrelevant. The method also includes analyzing a subset of query sub-rules from the plurality of query sub-rules, each query sub-rule from the subset corresponding to at least one of the selected social mentions. The method further includes modifying at least one of the query sub-rules in the query rule set based on the analysis of the subset of query sub-rules to filter out at least some irrelevant social mentions derived from the query rule set.

A further embodiment is directed to a computerized system comprising: one or more processors; and one or more computer storage media storing computer-useable instructions that, when used by the one or more processors, cause the one or more processors to: display a plurality of social mentions derived from a query rule set, the query rule set being comprised of a plurality of query sub-rules; receive inputs classifying selected social mentions from the plurality of social mentions, each of the selected social mentions being classified as one of relevant and irrelevant; analyze a subset of query sub-rules from the plurality of query sub-rules, each query sub-rule from the subset corresponding to at least one of the selected social mentions; and modify at least one of the query sub-rules in the query rule set based on the analysis of the subset of query sub-rules to filter out at least some irrelevant social mentions derived from the query rule set.

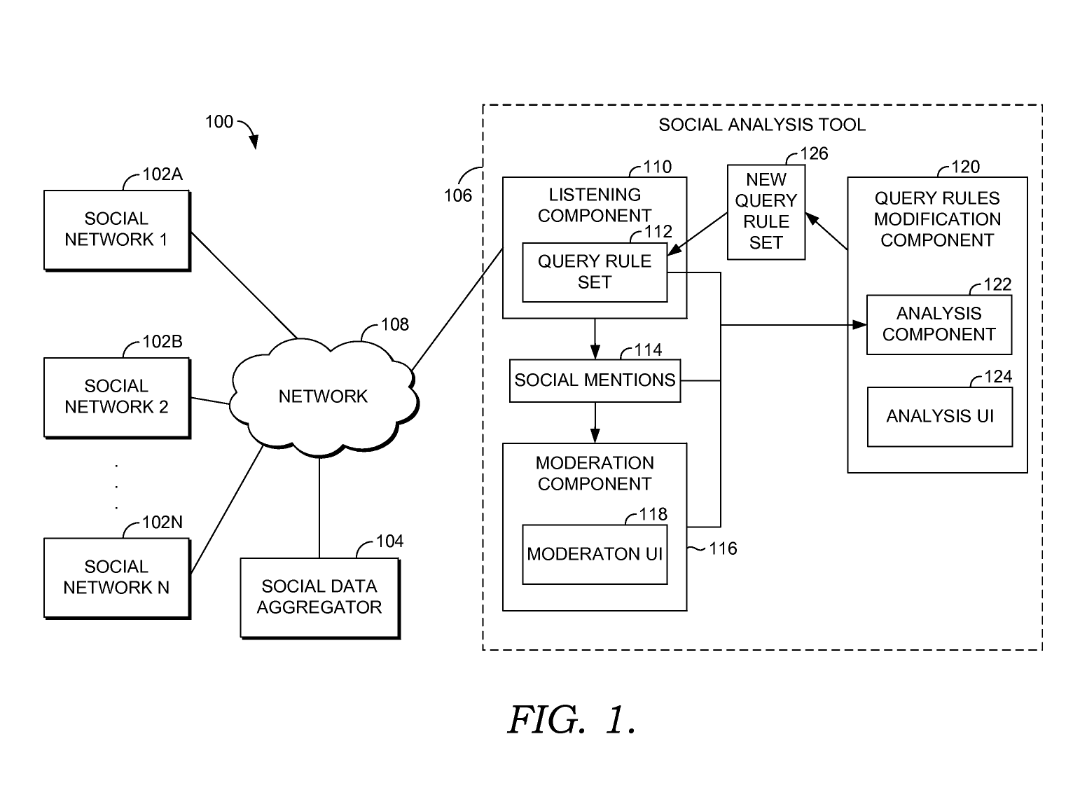

Turning now to FIG. 1, a block diagram is provided illustrating an exemplary system 100 in which some embodiments of the present invention may be employed. It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

Among other components not shown, the system 100 may include a number of social networking services 102A, 102B, 102N, a social data aggregator 104, and a social analysis tool 106. It should be understood that the system 100 shown in FIG. 1 is an example of one suitable computing system architecture. Each of the components shown in FIG. 1 may be implemented via any type of computing device, such as computing device 100 described with reference to FIG. 1, for example. The components may communicate with each other via a network 108, which may include, without limitation, one or more local area networks (LANs) and/or wide area networks (WANs). Such networking environments are commonplace in offices, enterprise-wide computer networks, intranets, and the Internet. It should be understood that any number of social networking services, social data aggregators, and social analysis tools may be employed within the system 100 within the scope of the present invention. Each may comprise a single device or multiple devices cooperating in a distributed environment. For instance, the social analysis tool 106 may be provided via multiple devices arranged in a distributed environment that collectively provide the functionality described herein. Additionally, other components not shown may also be included within the network environment.

The social analysis tool 106 may be employed by a company to assist in managing the company's brand. Among other things, the social analysis tool 106 operates to collect social data from social networking services 102A, 102B, 102N. As represented in FIG. 1, social data may be collected from any number of social networking services. These services generally include any online presence at which users may share messages with other users within a social network of users. In some instances, the social analysis tool 106 may access social data directly from a social networking service or an entity providing the social analysis tool 106 may access the data from a social networking service and provide the data to the tool 106. For instance, a social networking service may provide APIs that expose the data. In other instances, the social analysis tool 106 may access social data from a third-party social data aggregator 104 (e.g., the GNIP service), which may operate to access data from one or more social networking services, standardize the data, and provide the standardized data. Any and all such variations are contemplated to be within the scope of embodiments of the present invention.

As shown in FIG. 1, the social analysis tool 106 includes, among other things not shown, a listening component 110, moderation component 118, and query rules modification component 120. The listening component 110 includes a query rule set 112. The query rule set 112 includes one or more query sub-rules that set forth criteria used by the listening component 110 to identify particular social mentions to capture from the social data. The query rule set 112 may include any number of query sub-rules. In some cases, a single query sub-rule could be used to capture social mentions. In other cases, multiple query sub-rules may be used with different criteria. For instance, a first query sub-rule can be joined with another query sub-rule using a Boolean operator such as OR or AND.

The query rule set 112 may initially be defined by the company or on behalf of the company to satisfy whatever objectives the company may have. For instance, the company may generally define its objectives and an initial set of query sub-rules may be set based on those objectives. Generally, any aspect of social messages that may be of interest to a company may be included as criteria in a query sub-rule. The criteria may include specific terms or phrases included within social messages. For example, the terms may include the company's trademarks or terms relevant to the company's products, services, industry, or otherwise of interest to the company. The terms may be bare terms or may be terms associated with a hashtag or other term tagging mechanism employed by users. Any number of terms or phases may be included within the query sub-rules of the rule set 112.

The query sub-rules of the query rule set 112 may also set forth metadata criteria. In particular, a variety of metadata may be associated with each social message. This may include, for instance, information regarding: the author of the social message (e.g., demographic information, name or other identification, location, language the author claims to speak, number of messages previously captured by the query sub-rules for the author, Klout score, number of followers, etc.); number of comments, retweets, or other messages from other users on the social message; social networking service on which the social message was posted; and day/time when the social message was posted. The query sub-rules of the query rule set 112 may include criteria specifying different combinations of metadata.

The listening component 110 applies the query sub-rules of the query rule set 112 to social data accessed from social networking services 102A, 102B, 102N and/or the social data aggregator 104 to identify social mentions 114 that satisfy the criteria set forth by the query sub-rules. The social mentions 114 captured by the listening component 110 are provided to the moderation component 116.

The moderation component 116 includes a moderation user interface (UI) 118. The moderation UI 118 may be employed by a moderator to review the social mentions 114 captured by the listening component 110. The moderator may then take moderation actions on some of the social mentions. For instance, the moderation UI 118 can present social mentions 114 captured by the listening component 110, with each social mention being paired with an input control for classifying the social mention as relevant or irrelevant to the moderator. The input control may include any interface that facilitates moderator input for classifying one or more social mentions as being relevant or irrelevant. Each social mention can be individually selected for classification based on moderator input for the social mention.

The query rules modification component 120 generally operates to modify the existing query rule set 112 to generate a new query rule set 126 that improves upon the initial query rule set 112 to thereby better identify social mentions that are more likely to be relevant to the company and also more likely to be moderated, thereby reducing the overall number of social mentions that need to be reviewed by a moderator. Although the query rules modification component 120 is shown as part of the social analysis tool 106 in FIG. 1, it should be understood that the rule generation component 120 may be provided separate from a social analysis tool (e.g., as a stand-alone application or service) in other embodiments.

As shown in FIG. 1, the query rules modification component 120 includes an analysis component 122 that analyzes social mentions 114 captured using the query rule set 112 by evaluating the query sub-rules of the query rule set 112. The new query rule set 126 may be generated by either modifying the existing query rule set 112 (e.g., by adding new conditions to query sub-rules in the rule set 112, leaving existing query sub-rules alone, and/or removing query sub-rules from the rule set 112) or replacing the query rule set 112 with an entirely new set of query sub-rules.

The analysis component 122 may analyze information from social mentions 114 captured using the rule set 112. More particularly, the analysis component 122 may analyze aspects of the social mentions 114, such as, for instance, the text of the social mentions 114 and/or metadata associated with the social mentions 114. The metadata may include, by way of example only and not limitation, information regarding: the author of the social message (e.g., demographic information, name or other identification, location, language the author claims to speak, number of messages previously captured for the author, Klout score, number of followers, etc.); number of comments, retweets, or other messages from other users on the social message; social networking service on which the social message was posted; day/time when the social message was posted, criteria from a query sub-rule the social message satisfied, and scores/rankings applied to the social message (e.g., a sentiment score or emotion score or other metadata that reflects the user's sentiment or emotions connected with the message—positive, negative, happy, angry, sad, etc.).

The analysis component 122 analyzes social mentions 114 captured using the query rule set 112 by evaluating at least some of the individual query sub-rules of the query rule set 112. In embodiments, an initial query is executed using the query rule set 112, such that a plurality of social mentions derived therefrom is displayed to a moderator. As described above, the moderation component 116 receives classifying inputs from the moderator for selected social mentions from the plurality of social mentions, the classifications being one of relevant or irrelevant. The analysis component 122 evaluates each of the selected social mentions to determine which sub-rule in the query rule set 112 was responsible for capturing the selected social mention. In some embodiments, the analysis component 122 may determine more than one sub-rule as responsible for capturing the selected social mention, and in some instances, one sub-rule may be responsible for capturing multiple selected social mentions. The collective sub-rules responsible for capturing each selected social mention may form a subset of query sub-rules used by the analysis component 122 for further analysis. In some embodiments, the analysis component 122 may extract the subset prior to performing the further analysis. In other embodiments, the analysis component 122 determines, for each query sub-rule in the subset, whether the query sub-rule requires modification based at least on each the classifying inputs of the one or more selected social mentions associated with the query sub-rule.

In some embodiments, the analysis component's 122 determination of whether a query sub-rule requires modification will provide for one of removal of the query sub-rule from the query rule set 112, appending new conditions to the query sub-rule, or leaving the query sub-rule as-is. For instance, the analysis component 122 may evaluate all selected social mentions associated with a particular query sub-rule. If the analysis component 122 determines that all of the selected social mentions associated with the particular query sub-rule are classified as irrelevant, then the analysis component 122 may determine that the particular query sub-rule is to be removed from the query rule set 112. Further, if the analysis component 122 determines that all of the selected social mentions associated with the particular query sub-rule are classified as relevant, then the analysis component 122 may determine that the particular query sub-rule is not to be modified.

In some instances, the analysis component 122 may determine that a particular query sub-rule is associated with, or in other words responsible for capturing, at least one relevant and at least one irrelevant selected social mention. As such, the particular query sub-rule may be further processed for modification. For instance, a set of keywords from both the relevant and irrelevant selected social mentions are extracted. The keywords may be terms or entities in the selected social mentions that are identified as potential terms or entities that could be used with negations (i.e., preceded by a Boolean NOT operator) and appended to the particular query sub-rule to improve the filtering-out of irrelevant social mentions. Each of the keywords from the extracted set are iteratively appended to the particular query sub-rule so that distributions of relevant and irrelevant social mentions captured by the particular query sub-rule iteratively including each of the keywords are observed. In embodiments, at least one of the keywords from the extracted set may produce a relevance distribution capturing minimal irrelevant social mentions. As such, the at least one keyword capturing the least irrelevant social mentions is selected as the best keyword for inclusion into the particular query sub-rule. In some other embodiments, all possible combinations of the keywords are also iteratively appended to the particular query sub-rule to determine the best combination of keywords to append to the particular query sub-rule for filtering out irrelevant social mentions.

An analysis UI 124 may be provided that presents the new query rule set 126 to a user. This allows the user to review details of the new query rule set 126 and make a determination regarding whether to implement the new query rule set 126. For instance, the analysis UI 124 may provide a control that allows the user to accept the new query rule set 126 for implementation or to reject the new query rule set 126. In some embodiments, the analysis UI 124 may be configured to allow the user to make manual changes to the new query rule set 126. For instance, the analysis UI 124 may present details of the new query rule set 126, including the various criteria included in the query sub-rules of the new query rule set 126. The user may view the criteria and make changes if desired. Any changes made by the user may be applied to the new query rule set 126.

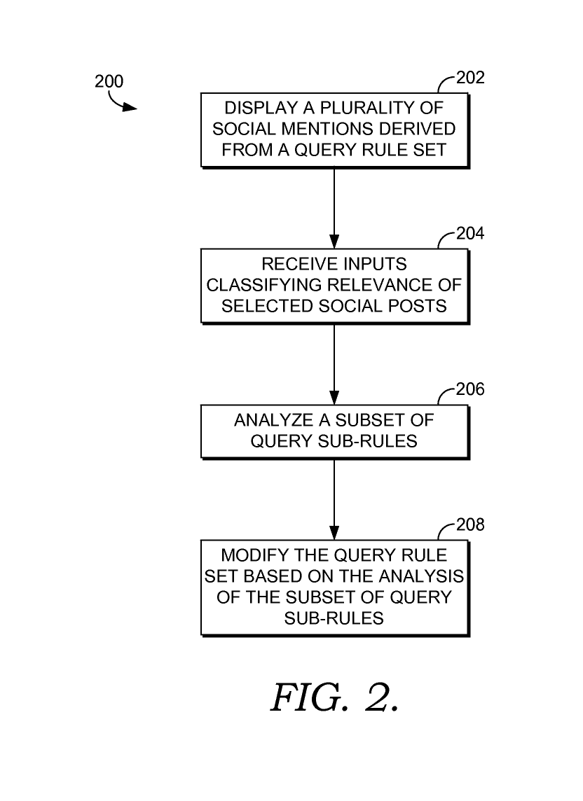

Turning now to FIG. 2, a flow diagram is provided that illustrates a method 200 for modifying existing social query rule sets in order to reduce the number of irrelevant social mentions while providing social mentions that are likely to be of relevance to the company and moderated. Each block of the method 200 and other methods described herein comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a service or hosted service (standalone or in combination with another hosted service), or a plug-in to another product, to name a few. For example, the methods may be provided as part of a social analysis tool, such as the ADOBE SOCIAL tool.

As shown at block 202, a plurality of social mentions derived from a query rule set (for instance, by listening component 110 of FIG. 1) are displayed for moderation. The displaying of social mentions may include identifying social mentions that meet the query criteria using the query rule set.

Inputs classifying selected social mentions from the plurality of social mentions are received (for instance, by the moderation component 116 of FIG. 1), as shown at block 204. The inputs may include a selecting of any one or more social mentions, at the discretion of the moderator, to classify the one or more social mentions as relevant or irrelevant to the moderator's desired query. Based on the current query rule set, the moderator reviews the currently captured social mentions, and selectively classifies any number of social mentions as being relevant or irrelevant to the query to further modify the query rule set.

A subset of query sub-rules from the plurality of query sub-rules is extracted and analyzed (for instance, by the analysis component 122 of FIG. 1). Each query sub-rule in the subset corresponds to at least one of the selected social mentions. As such, each of the selected social mentions is associated with, or in other words is captured by the query rule set as a result of, at least one query sub-rule in the subset. In some embodiments, it is possible that all query sub-rules from the plurality of sub-rules are included in the subset. In such embodiments, each of the query sub-rules in the query rule set would have captured at least one of the selected social mentions.

In some embodiments, a determination of whether a query sub-rule requires modification may provide for one of removal of the query sub-rule from the query rule set, appending new conditions to the query sub-rule, or leaving the query sub-rule as-is. For instance, all selected social mentions associated with a particular query sub-rule are analyzed. If a determination is made that all of the selected social mentions associated with the particular query sub-rule are classified as irrelevant, then the particular query sub-rule may be removed from the query rule set. In the alternative, if a determination is made that all of the selected social mentions associated with the particular query sub-rule are classified as relevant, then the particular query sub-rule is left unmodified.

In some instances, a particular query sub-rule may be associated with, or in other words responsible for capturing, at least one relevant and at least one irrelevant selected social mention. As such, the particular query sub-rule may be further processed for modification. For instance, a set of keywords from both the relevant and irrelevant selected social mentions are extracted. The keywords may be terms or entities in the selected social mentions that are identified as potential terms or entities that could be used with negations (i.e., a Boolean NOT operator) and appended to the particular query sub-rule to improve the filtering out of irrelevant social mentions. Each of the keywords from the extracted set may be iteratively appended to the particular query sub-rule so that distributions of relevant and irrelevant social mentions captured by the particular query sub-rule iteratively including each of the keywords are observed. In embodiments, at least one of the keywords from the extracted set may produce a relevance distribution capturing minimal irrelevant social mentions. As such, the at least one keyword capturing the least irrelevant social mentions is selected as the best keyword for inclusion into the particular query sub-rule. In some other embodiments, all possible combinations of the keywords may also be iteratively appended to the particular query sub-rule and observed to determine the best combination of keywords to append to the particular query sub-rule for filtering out irrelevant social mentions.

The query rule set is modified (for instance, by the query rules modification component 120 of FIG. 1) based on the analysis of the query sub-rules, as shown at block 208. The modification of the rule set may result in a new rule set that may include one or more query sub-rules with criteria selected based on the analysis of the query sub-rules to better capture social mentions that are more likely to be relevant to the company and more likely to be moderated. As a result, the new rule set will reduce the number of irrelevant social mentions that will be captured. In some instances, the new rule set may be generated by modifying the initial rule set (e.g., by modifying existing query sub-rules of the initial rule set, adding new captures rules to the initial rule set, and/or removing query sub-rules from the initial rule set). In some instances, the new rule set may be generated by providing an entirely new rule set independent of the initial rule set.

The new rule set is applied for the purpose of capturing new more relevant social data. For instance, the analysis component 122 of FIG. 1 may update the rule set of the listening component 110, which may capture new social data using the new rule set. In some instances, the new rule set may be applied automatically by the system. In other instances, the new rule set may be presented to a user, who may decide whether to apply the new rule set. Additionally, in some instances, the user may be given the ability to modify the new rule set before applying the new rule set to capture new social data.

It should be understood that in some embodiments, the process of receiving inputs classifying captured social mentions may be repeated after applying a new rule set to update and continuously improve the rule set used by the system.

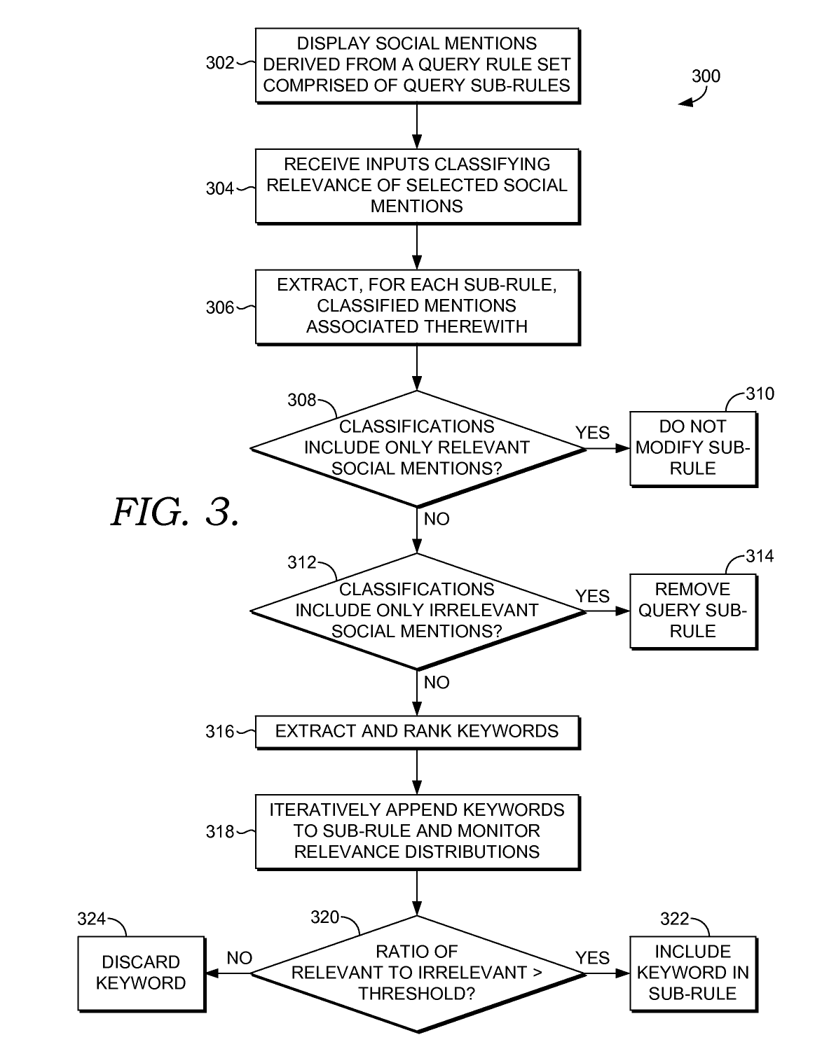

Turning now to FIG. 3, a flow diagram is provided that illustrates a method 300 for modifying existing social query rule sets in order to reduce the number of irrelevant social mentions while providing social mentions that are likely to be of relevance to the company and moderated. Initially, as shown at block 302, a plurality of social mentions derived from a query rule set (for instance, using the listening component 110 of FIG. 1) is displayed to a user. The user may be a moderator or an administrator responsible for coordinating the social analysis program for a company. The user may review the resulting social mentions derived from the query rule set, including the criteria of the query rule set. Display of the social mentions derived from the query rule set can be displayed to the moderator using, for instance, the moderation UI 118 of FIG. 1.

In some instances, the user may choose to classify any number of social mentions as being relevant or irrelevant. For instance, if the user perceives the results of his initial query rule set as being too broad, that is, capturing too many irrelevant social mentions, the query sub-rules responsible for capturing the irrelevant social mentions need to be isolated and modified. As such, to facilitate such a modification, inputs are received at block 304 (for instance, by the moderation component 116 of FIG. 1) by the user for classifying a plurality of social mentions as being either relevant or irrelevant. For each query sub-rule in the query rule set, only the social mentions that are classified by the user and associated to the query sub-rule are extracted and/or analyzed for modification, as shown at block 306. For instance, social mentions being captured by the query rule set as a result of a particular query sub-rule in the query rule set would be associated with the particular query sub-rule. In some embodiments, only query sub-rules associated with at least one classified social mention and comprising more than one element, term, or phrase in the query sub-rule (i.e., elements within the sub-rule joined by a Boolean operator) are analyzed and processed for modification. In some embodiments, a subset of query sub-rules is comprised of all query sub-rules from the query rule set that are associated to at least one classified social mention. In some other embodiments, this subset of query sub-rules can be extracted for further analysis and modification.

For each sub-rule extracted and/or analyzed for modification, in other words for each sub-rule in the subset, all social mentions associated therewith are analyzed to determine if all are classified as relevant, as shown at block 308. If all social mentions associated therewith are determined to be classified as relevant, the query sub-rule remains unmodified, as shown at block 310. Alternatively, if it is determined that all social mentions associated therewith are determined to be classified as irrelevant, as shown at block 312, the entire query sub-rule is removed from the query rule set, as shown at block 314. In some instances, the set of social mentions associated therewith may include both relevant and irrelevant classifications. If so, the keywords (e.g., terms or entities) in each of the associated social mentions are identified as potential keywords that could be associated with the irrelevant social mentions. For instance, some of the terms or entities added to the sub-rule as a negative limitation (i.e., a Boolean operator “NOT”) could potentially remove irrelevant social mentions captured therefrom. As such, each keyword from the social mentions are extracted and/or ranked based on the number of social mentions containing the keyword, as shown at block 316. In some embodiments, only a predefined number of highly-ranked keywords are retained for processing. In other embodiments, an analysis can be performed on the keyword distribution to determine which keywords, having a statistically high occurrence rate, should be retained for processing.

After the keywords are extracted and/or ranked, and retained for processing, the given query sub-rule is iteratively appended with each of the keywords, exhausting all various configurations of each keyword with the query sub-rule, to monitor changes in the distribution of relevant and irrelevant social mentions for each modified query sub-rule, as shown at block 318. In monitoring the distribution changes of relevance, one or more keywords can be joined to the query sub-rule in a manner that filters out social mentions captured by the one or more keywords (i.e., using a Boolean operator “NOT”). For instance, for each keyword being analyzed in the newly modified queries, if a computed ratio of relevant social mentions to irrelevant social mentions surpasses an empirically determined threshold, as shown at block 320, then the keyword is included in the query sub-rule, as shown at block 322. Otherwise, the keyword is discarded, as shown at block 324. In some embodiments, a variable quality parameter can be modified, for instance, by a moderator via the moderation UI 118 of FIG. 1. In some embodiments, the quality parameter can be varied to modify the quality of distributions resulting from the analysis and modification of the query sub-rules.

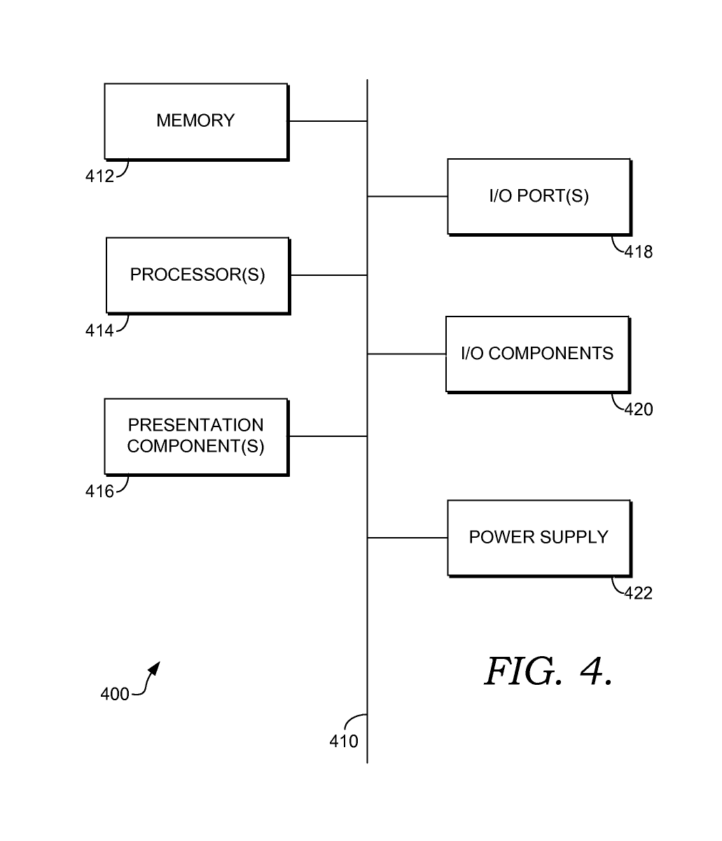

Having described embodiments of the present invention, an exemplary operating environment in which embodiments of the present invention may be implemented is described below in order to provide a general context for various aspects of the present invention. Referring initially to FIG. 4 in particular, an exemplary operating environment for implementing embodiments of the present invention is shown and designated generally as computing device 400. Computing device 400 is but one example of a suitable computing environment and is not intended to suggest any limitation as to the scope of use or functionality of the invention. Neither should the computing device 400 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 4, computing device 400 includes a bus 410 that directly or indirectly couples the following devices: memory 412, one or more processors 414, one or more presentation components 416, input/output (I/O) ports 418, input/output components 420, and an illustrative power supply 422. Bus 410 represents what may be one or more busses (such as an address bus, data bus, or combination thereof). Although the various blocks of FIG. 4 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventor recognizes that such is the nature of the art, and reiterate that the diagram of FIG. 4 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 4 and reference to “computing device.”

Computing device 400 typically includes a variety of computer-readable media. Computer-readable media can be any available media that can be accessed by computing device 400 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 400. Computer storage media does not comprise signals per se. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 412 includes computer-storage media in the form of volatile and/or nonvolatile memory. The memory may be removable, non-removable, or a combination thereof. Exemplary hardware devices include solid-state memory, hard drives, optical-disc drives, etc. Computing device 400 includes one or more processors that read data from various entities such as memory 412 or I/O components 420. Presentation component(s) 416 present data indications to a user or other device. Exemplary presentation components include a display device, speaker, printing component, vibrating component, etc.

I/O ports 418 allow computing device 400 to be logically coupled to other devices including I/O components 420, some of which may be built in. Illustrative components include a microphone, joystick, game pad, satellite dish, scanner, printer, wireless device, etc. The I/O components 420 may provide a natural user interface (NUI) that processes air gestures, voice, or other physiological inputs generated by a user. In some instance, inputs may be transmitted to an appropriate network element for further processing. A NUI may implement any combination of speech recognition, touch and stylus recognition, facial recognition, biometric recognition, gesture recognition both on screen and adjacent to the screen, air gestures, head and eye tracking, and touch recognition associated with displays on the computing device 400. The computing device 400 may be equipped with depth cameras, such as, stereoscopic camera systems, infrared camera systems, RGB camera systems, and combinations of these for gesture detection and recognition. Additionally, the computing device 400 may be equipped with accelerometers or gyroscopes that enable detection of motion. The output of the accelerometers or gyroscopes may be provided to the display of the computing device 400 to render immersive augmented reality or virtual reality.

As can be understood, embodiments of the present invention provide for, among other things, automatically modifying existing search queries based on relevance feedback from social mentions. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. A non-transitory computer storage medium storing computer-useable instructions that, when used by one or more computing devices, cause the one or more computing devices to perform operations comprising:
displaying a plurality of social mentions derived from a query rule set, the query rule set being comprised of a plurality of query sub-rules;
receiving inputs classifying selected social mentions from the plurality of social mentions, each of the selected social mentions being classified as one of relevant and irrelevant;
analyzing a subset of query sub-rules from the plurality of query sub-rules, each query sub-rule from the subset corresponding to at least one of the selected social mentions; and
modifying at least one of the query sub-rules in the subset based on the analysis of the subset of query sub-rules to filter out at least some irrelevant social mentions derived from the query rule set.

2. The non-transitory computer storage medium of claim 1, wherein each selected social mention corresponds to at least one query sub-rule.

3. The non-transitory computer storage medium of claim 1, wherein when at least one irrelevant selected social mention and no relevant selected social mentions correspond to a particular query sub-rule in the plurality of query sub-rules, the particular query sub-rule is removed from the query rule set.

4. The non-transitory computer storage medium of claim 1, wherein when at least one relevant selected social mention and at least one irrelevant selected social mention both correspond to a particular query sub-rule in the plurality of query sub-rules, the particular query sub-rule is further processed for modification.

5. The non-transitory computer storage medium of claim 4, wherein the particular query sub-rule is further processed for modification by extracting a set of top keywords from both the at least one relevant selected social mention and the at least one irrelevant selected social mention and iteratively appending each of the top keywords from the set to the particular query sub-rule to determine useful keywords to further filter out irrelevant social mentions.

6. The non-transitory computer storage medium of claim 5, wherein when iteratively appending each of the top keywords from the set to the particular query sub-rule, a distribution of relevant and irrelevant social mentions are observed to determine inclusion of a best keyword from the useful keywords into the particular query sub-rule.

7. The non-transitory computer storage medium of claim 1, wherein the modifying at least one of the query sub-rules in the query rule set is adjusted by a variable quality parameter.

8. A computer-implemented method comprising:
displaying, by a computing device, a plurality of social mentions derived from a query rule set, the query rule set being comprised of a plurality of query sub-rules;
receiving inputs classifying selected social mentions from the plurality of social mentions, each of the selected social mentions being classified as one of relevant and irrelevant;
analyzing a subset of query sub-rules from the plurality of query sub-rules, each query sub-rule from the subset corresponding to at least one of the selected social mentions; and
modifying at least one of the query sub-rules in the subset based on the analysis of the subset of query sub-rules to filter out at least some irrelevant social mentions derived from the query rule set.

9. The computer-implemented method of claim 8, wherein each selected social mention corresponds to at least one query sub-rule.

10. The computer-implemented method of claim 8, wherein when at least one irrelevant selected social mention and no relevant selected social mentions correspond to a particular query sub-rule in the plurality of query sub-rules, the particular query sub-rule is removed from the query rule set.

11. The computer-implemented method of claim 8, wherein when at least one relevant selected social mention and at least one irrelevant selected social mention both correspond to a particular query sub-rule in the plurality of query sub-rules, the particular query sub-rule is further processed for modification.

12. The computer-implemented method of claim 8, wherein the particular query sub-rule is further processed for modification by extracting a set of top keywords from both the at least one relevant selected social mention and the at least one irrelevant selected social mention and iteratively appending each of the top keywords from the set to the particular query sub-rule to determine useful keywords to further filter out irrelevant social mentions.

13. The computer-implemented method of claim 12, wherein when iteratively appending each of the top keywords from the set to the particular query sub-rule, a distribution of relevant and irrelevant social mentions are observed to determine inclusion of a best keyword from the useful keywords into the particular query sub-rule.

14. The computer-implemented method of claim 12, wherein the modifying at least one of the query sub-rules in the query rule set is adjusted by a variable quality parameter.

15. A computerized system comprising:
one or more processors; and
one or more computer storage media storing computer-useable instructions that, when used by the one or more processors, cause the one or more processors to:
display a plurality of social mentions derived from a query rule set, the query rule set being comprised of a plurality of query sub-rules;
receive inputs classifying selected social mentions from the plurality of social mentions, each of the selected social mentions being classified as one of relevant and irrelevant;
extract for analysis, a subset of query sub-rules from the plurality of query sub-rules, each query sub-rule from the subset corresponding to at least one of the selected social mentions;
determine, for each query sub-rule in the subset, whether the query sub-rule requires modification based at least on each of the classifying inputs of the one or more selected social mentions associated therewith;
modify at least one of the query sub-rules in the subset based on the determination whether each query sub-rule in the subset requires modification to filter out at least some irrelevant social mentions derived from the query rule set.

16. The computerized system of claim 15, wherein each selected social mention corresponds to at least one query sub-rule.

17. The computerized system of claim 15, wherein when at least one irrelevant selected social mention and no relevant selected social mentions correspond to a particular query sub-rule in the plurality of query sub-rules, the particular query sub-rule is removed from the query rule set.

18. The computerized system of claim 15, wherein the modifying at least one of the query sub-rules in the query rule set is adjusted by a variable quality parameter.

19. The computerized system of claim 15, wherein when at least one relevant selected social mention and at least one irrelevant selected social mention both correspond to a particular query sub-rule in the plurality of query sub-rules, the particular query sub-rule is further processed for modification.

20. The computerized system of claim 19, wherein the particular query sub-rule is further processed for modification by extracting a set of top keywords from both the at least one relevant selected social mention and the at least one irrelevant selected social mention and iteratively appending each of the top keywords from the set to the particular query sub-rule to determine useful keywords to further filter out irrelevant social mentions.
